(19) United States
(12) Patent Application Publication
(10) Pub. No.: US 2026/0368353 A1
(43) Pub. Date: Nov. 19, 2026

(54) INFORMATION PROCESSING METHOD AND INFORMATION PROCESSING SYSTEM

(71) Applicant: Hitachi, Ltd., Tokyo (JP)

(72) Inventors: Keisei FUJIWARA, Tokyo (JP); Hisayoshi SATO, Tokyo (JP)

(21) Appl. No.: 19/153,698

(22) PCT Filed: May 9, 2024
(86) PCT No.: PCT/JP2024/017207

§ 371 Date: Aug. 5, 2025

(30) Foreign Application Priority Data
May 15, 2023 (JP) 2023-079973

(51) Int. Cl. G06F 21/62; G06N 3/0464

(52) U.S. Cl. CPC G06F 21/6245; G06N 3/0464

(57) ABSTRACT

In an information processing method by a neural network, parameter concealment influence removal processing of dividing an execution result of an i-th layer processing unit executed on concealment input data based on a concealment machine learning parameter by a parameter protection random number in a normal region is executed in a confidence region. Then, input concealment influence removal processing of subtracting an input concealment influence removal parameter from an execution result of the parameter concealment influence removal processing is executed, and an inference result is output.

### TECHNICAL FIELD

The present invention relates to a confidential information processing method and confidential information processing.

### BACKGROUND ART

In recent years, there has been progress in schemes for utilizing personal data through collaboration between the public and private sectors. For example, new value is created by linking various types of information, such as by linking public services and private services. To create a new value by linking various types of information, statistical analysis such as regression analysis, and machine learning such as convolutional neural network (CNN) are effective. Statistical analysis and machine learning are also provided as a platform that can be easily implemented by various companies using public clouds and the like that can be used at a low cost.

Meanwhile, regulation enhancement for an object of privacy protection has also progressed. Therefore, there is a demand for a technique of using confidential information owned by data holders such as hospitals, banks, or the like in a concealed state.

Against such a background, the creation of a new value by linking various types of information has been promoted, such as public services in which information between the public and private sectors, such as emergency and security companies, are linked, and linking between private services such as pharmaceuticals, insurance, transportation, and information banks that create synergy with the public services. To create a new value by analyzing various types of data, analysis processing such as statistical analysis such as regression analysis and machine learning is effective. To implement these services, there is a demand for a confidential information processing technique that enables a provider of the public service or the private service to analyze and utilize confidential information such as personal information owned by the data holder such as a hospital, a bank, or the like while protecting personal privacy.

The related art enables specific processing while keeping the data encrypted, thereby implementing the utilization of confidential information in a concealed state. However, the processing that can be executed in the related art is limited to basic processing such as search and order comparison, and there is a limit to the degrees of freedom of the processing. Therefore, there is a demand for a technique capable of that can handle advanced statistical processing requiring a high degree of freedom in processing and image processing using machine learning such as a CNN.

In recent years, a central processing unit (CPU) has been equipped with a trusted execution environment (TEE) function. The TEE function is considered to be effective for processing the confidential information. The TEE function is a function of providing a confidence region in which the information cannot be read even when an administrator authority of the OS running on the computer is stolen. By decrypting and processing the encryption data in the confidence region, secure and advanced processing can be performed.

Techniques of using a confidence region of the TEE function include a technique disclosed in PTL 1. PTL 1 discloses a privacy-enhanced deep learning system that reduces information leakage of confidential input data in an inference pipeline.

The technique disclosed in PTL 1 uses a hierarchical structure of a neural network to divide each deep learning model into a FrontNet for processing in a confidence region and a BackNet for processing in a normal region.

In the technique disclosed in PTL 1, a terminal used by an end user transmits an encrypted input and an encrypted FrontNet to a system. The technique disclosed in PTL 1 uses a TEE function on a cloud infrastructure to perform processing of Deep Learning processing in an autoclave (isolation execution process in the TEE function) of the FrontNet, thereby protecting confidentiality and integrity of a user input by encryption.

Meanwhile, in the technique disclosed in PTL 1, when a safe autoclave is insufficient in BackNet inference calculation and a deep learning acceleration chip such as a graphical processing unit (GPU) is mounted on a cloud machine, an advantage of the improvement in performance is obtained.

The technique disclosed in PTL 1 uses the hierarchical structure of the neural network to divide each deep learning model into the FrontNet and the BackNet to determine a model-specific optimal split point that balances privacy protection and performance requirements. In the technique disclosed in PTL 1, a deep learning inference system measures similarity for each set of intermediate data in each layer and uses a selected subset of the intermediate data that is most similar to input information to determine a split point to be used for splitting into two partitions.

Techniques of using a confidence region of a TEE function include a technique described in NPL 1. NPL 1 discloses a concealment method of confidential input data that reduces information leakage of confidential input data input to a GPU in an inference pipeline that utilizes the GPU to speed up linear arithmetic processing in Deep Learning.

### CITATION LIST

### Patent Literature

PTL 1: US2020/0082259

### Non Patent Literature

NPL 1: F. Tramer and D. Boneh, “Slalom: Fast, verifiable and private execution of neural networks intrusted hardware,” in International Conference on Learning Representations (ICLR), 2019.

### SUMMARY OF INVENTION

### Technical Problem

However, the system disclosed in PTL 1 may not be able to prevent the leakage of confidential information during Deep Learning processing on unknown input information when the unknown input information includes confidential information that is not learned during the learning stage, such as personal privacy information or trade secrets. Specifically, in the BackNet, since machine learning parameters constituting the deep learning model are processed in the normal region, leakage of the deep learning model cannot be prevented when the machine learning parameters are confidential information.

In the concealment method disclosed in NPL 1, since machine learning parameters used for the linear arithmetic processing, which is a part of the deep learning model, are processed without being concealed by the GPU in the normal region, leakage of the machine learning parameters cannot be prevented when the machine learning parameters are confidential information.

Therefore, an object of one aspect of the invention is to protect machine learning parameters that are confidential information during processing such as machine learning using a plurality of processing layers.

### Solution to Problem

To solve the above problems, one aspect of the invention adopts the following configuration. That is, provided is an information processing method performed by an information processing system configured to execute information processing by a neural network including a plurality of i-th layers (i is a natural number of 1 or more and N or less), in which the information processing system includes a processor and a memory, the memory has an isolation region that is a trusted execution environment (TEE) isolated from a normal region, the isolation region holds an i-th layer parameter used for processing of the i-th layer, an i-th layer parameter protection random number that is a random number for protecting the i-th layer parameter, an i-th layer input data to be input to the i-th layer, and an i-th layer input data protection random number that is a random number for protecting the i-th layer input data, and in the isolation region, the processor executes processing including executing, for each of the i-th layers, parameter concealment processing of generating an i-th layer concealment parameter in which the i-th layer parameter is concealed by multiplying the i-th layer parameter by the i-th layer parameter protection random number, and outputting the i-th layer concealment parameter to the normal region, executing, for each of the i-th layers, input concealment influence removal parameter generation processing of generating an i-th layer input data concealment removal parameter for removing concealment applied to the i-th layer input data by multiplying the i-th layer parameter by the i-th layer input data protection random number and holding the generated i-th layer input data concealment removal parameter in the isolation region, executing concealment input data generation processing of generating i-th layer concealment input data in which the i-th layer input data is concealed by adding the i-th layer input data protection random number to the i-th layer input data, and outputting the i-th layer concealment input data to the normal region as the i-th layer input data, executing parameter concealment influence removal processing of acquiring, from the normal region, an execution result of the processing of the i-th layer executed on the i-th layer concealment input data based on the i-th layer concealment parameter in the normal region and of dividing the execution result by the i-th layer parameter protection random number, and executing input concealment influence removal processing of subtracting the i-th layer input data concealment removal parameter from an execution result of the parameter concealment influence removal processing, and setting an execution result of the input concealment influence removal processing as i-th layer output data output from the i-th layer.

### Advantageous Effects of Invention

According to an aspect of the invention, it is possible to protect machine learning parameters that are confidential information during processing such as machine learning by a plurality of processing layers.

Problems, configurations, and effects other than those described above will become apparent by description of the following embodiment.

### BRIEF DESCRIPTION OF DRAWINGS

FIG. 1 is a block diagram illustrating a system configuration example of a confidential information processing system.

FIG. 2 is a block diagram illustrating a hardware structure example of the confidential information processing system.

FIG. 3 is a diagram illustrating a functional configuration example for confidential inference processing and an example of a data processing flow.

FIG. 4 is a sequence diagram illustrating an example of a data processing flow of confidential inference preparation processing.

FIG. 5 is a sequence diagram illustrating an example of a data processing flow of confidential inference execution processing.

FIG. 6 is a flowchart illustrating an example of parameter concealment processing.

FIG. 7 is a flowchart illustrating an example of input concealment influence removal parameter generation processing.

FIG. 8 is a flowchart illustrating an example of concealment input data generation processing.

FIG. 9 is a flowchart illustrating an example of parameter concealment influence removal processing.

FIG. 10 is a flowchart illustrating an example of input concealment influence removal processing.

FIG. 11 is a dialog diagram illustrating an example of a machine learning parameter concealment setting information input screen.

FIG. 12 is a table illustrating an example of each-layer processing concealment setting information table.

### DESCRIPTION OF EMBODIMENTS

Hereinafter, an embodiment of the invention will be described in detail with reference to the drawings. In the present embodiment, the same components are denoted by the same reference numerals in principle, and repeated description thereof is omitted. The present embodiment is merely an example for implementing the invention and does not limit the technical scope of the invention.

### (1) Configuration Example of Confidential Information Processing System 1

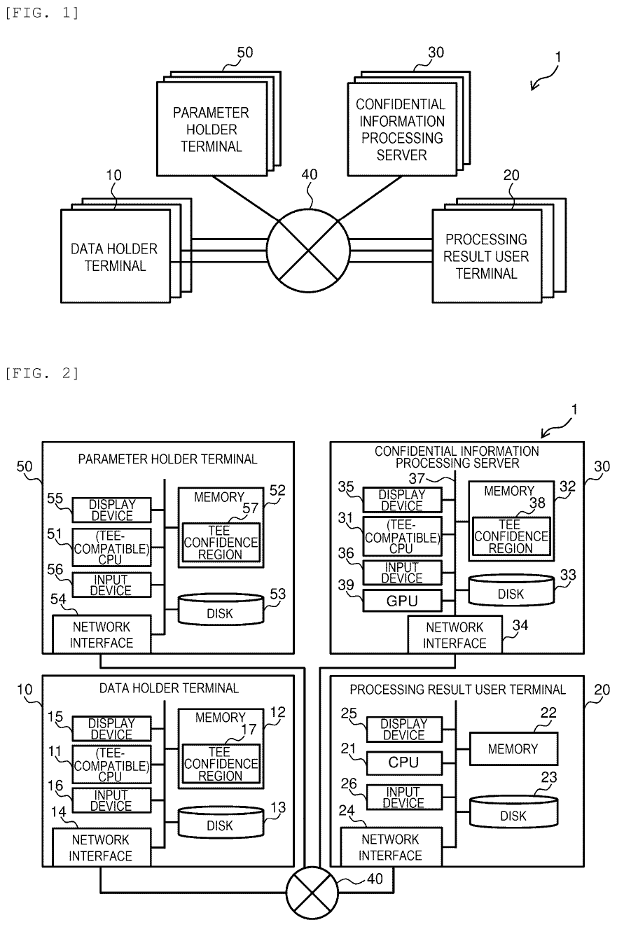

FIG. 1 is a block diagram illustrating a system configuration example of a confidential information processing system 1. The confidential information processing system 1 is deposited with encrypted machine learning parameters and the like from a parameter holder that holds confidential information that is a trade secret such as machine learning parameters. The confidential information processing system 1 is also deposited with encrypted data from a data holder that holds confidential information such as personal information. The confidential information processing system 1 processes the deposited machine learning parameters and data in response to a processing request from a processing result user while concealing the confidential information, and provides the processing result to the processing result user.

The confidential information processing system 1 includes, for example, a parameter holder terminal 50 used for encrypting and depositing the machine learning parameters and the like by the parameter holder. The confidential information processing system 1 also includes a data holder terminal 10 used by the data holder to encrypt and deposit data. The confidential information processing system 1 includes a processing result user terminal 20 with which the processing result user generates and transmits the processing request and refers to the processing result. The confidential information processing system 1 includes a confidential information processing server 30 that executes the processing of the processing request received from the processing result user on the data deposited from the data holder based on the machine learning parameters and the like deposited from the parameter holder in a concealing way and transmits the processing result. The parameter holder terminal 50, the data holder terminal 10, the processing result user terminal 20, and the confidential information processing server 30 are connected to one another via a network 40 such as the Internet.

The confidential information processing system 1 may include a plurality of the parameter holder terminals 50, may include a plurality of the data holder terminals 10, may include a plurality of the processing result user terminals 20, and may include a plurality of the confidential information processing servers. The parameter holder terminal 50 and the data holder terminal 10 may be the same terminal, and the data holder terminal 10 and the processing result user terminal 20 may be the same terminal.

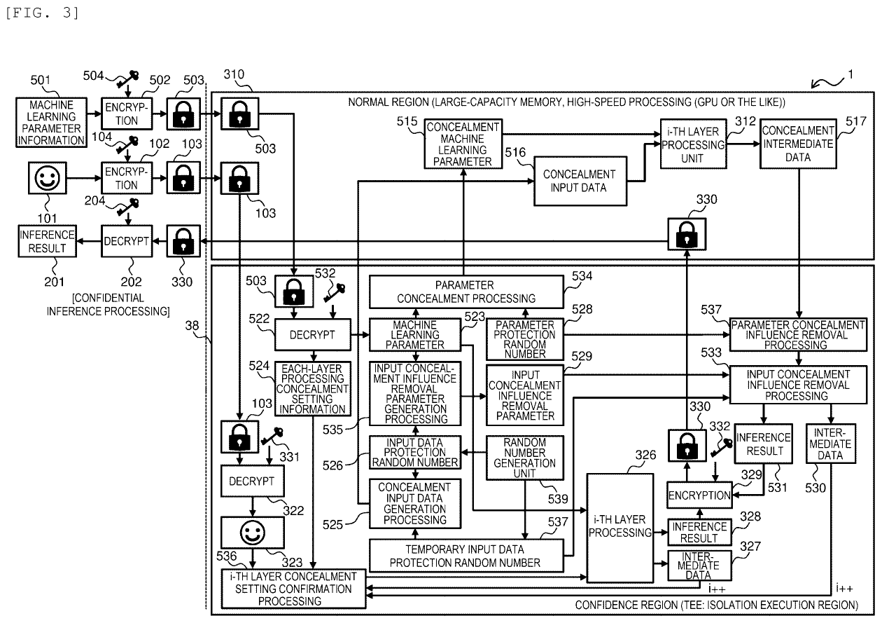

FIG. 2 is a block diagram illustrating a hardware structure example of the confidential information processing system 1. The data holder terminal 10 is, for example, a computer such as a personal computer, a smartphone, or a server device, or a virtual computer. For example, the data holder terminal 10 is implemented by a computer including a central processing unit (CPU) 11, a memory 12, an auxiliary storage device 13, a network interface 14, a display device 15, and an input device 16, which are connected to one another by an internal communication line.

The CPU 11 includes a processor and executes a program stored in the memory 12. The memory 12 includes a read only memory (ROM) that is a non-volatile storage element and a random access memory (RAM) that is a volatile storage element. The ROM stores immutable programs (for example, a basic input/output system (BIOS)) and the like. The RAM is a high-speed and volatile storage element such as a dynamic random access memory (DRAM), and temporarily stores the program executed by the CPU 11 and data used when the program is executed.

The CPU 11 is a TEE-compatible CPU having a trusted execution environment (TEE) function, and the memory 12 has a TEE confidence region 17 that is a hardware confidence region ensured on the memory by a TEE-compatible CPU 11 and is isolated from other regions on the memory. In a first embodiment, the CPU 11 may not have the TEE function, and the memory 12 may not have the TEE confidence region 17. An amount of memory that can be handled in the TEE confidence region 17 may be limited to be smaller than an amount of memory in the normal region (for example, about 128 MB), and in this case, when the CPU 11 executes processing on the TEE confidence region 17, a processing speed decreases as compared with the case of executing processing on the normal region.

The auxiliary storage device 13 is, for example, a large-capacity and non-volatile storage device such as a magnetic storage device (hard disk drive (HDD)) or a flash memory (solid state drive (SSD)), and stores the program executed by the CPU 11 and the data used when the program is executed. That is, the program is read from the auxiliary storage device 13, loaded on the memory 12, and executed by the CPU 11.

The display device 15 is a device that outputs an execution result of the program in a format that can be visually recognized by an operator, such as a display or a printer. The input device 16 is a device that receives inputs from the operator, such as a keyboard or a mouse. The network interface 14 controls communication with other devices according to a predetermined protocol. The network interface 14 may include, for example, a serial interface such as USB.

The program executed by the CPU 11 may be stored in advance in the non-volatile auxiliary storage device 13 which is a computer-readable non-transitory storage medium, or may be a removable medium (CD-ROM, flash memory, or the like) which is a non-transitory storage medium. Alternatively, the program may be provided to the data holder terminal 10 from a non-transitory storage device of another device via the network and stored in the auxiliary storage device 13. Therefore, the data holder terminal 10 may include an interface for reading data from the removable medium. The same applies to the processing result user terminal 20 and the confidential information processing server 30.

A part or all of functions implemented by functional units executed by the CPU and the GPU in the present embodiment may be implemented by hardware such as an application specific integrated circuit (ASIC) or a field-programmable gate array (FPGA).

In the present embodiment, information used by the confidential information processing system 1 may be expressed by any data structure without depending on the data structure, and for example, the information can be stored in a data structure appropriately selected from a list, a table, a database, or a queue.

The parameter holder terminal 50 is, for example, a computer such as a personal computer, a smartphone, or a server device, or a virtual computer. For example, the parameter holder terminal 50 is implemented by a computer including a CPU 51, a memory 52, an auxiliary storage device 53, a network interface 54, a display device 55, and an input device 56, which are connected to one another by an internal communication line.

The CPU 51, the memory 52, the auxiliary storage device 53, the network interface 54, the display device 55, and the input device 56 are the same as the hardware of the CPU 11, the memory 12, the auxiliary storage device 13, the network interface 14, the display device 15, and the input device 16, respectively. However, the CPU 51 does not need to have the TEE function, and it is not necessary to configure a confidence region in the memory 52.

The processing result user terminal 20 is, for example, a computer such as a personal computer, a smartphone, or a server device, or a virtual computer. For example, the processing result user terminal 20 is implemented by a computer including the CPU 21, a memory 22, an auxiliary storage device 23, a network interface 24, a display device 25, and an input device 26, which are connected to one another by an internal communication line.

The CPU 21, the memory 22, the auxiliary storage device 23, the network interface 24, the display device 25, and the input device 26 are the same as the hardware of the CPU 11, the memory 12, the auxiliary storage device 13, the network interface 14, the display device 15, and the input device 16, respectively. However, the CPU 21 does not need to have the TEE function, and it is not necessary to configure a confidence region in the memory 22.

The confidential information processing server 30 is, for example, a computer such as a personal computer, a smartphone, or a server device, or a virtual computer. For example, the confidential information processing server 30 is implemented by a computer including a CPU 31, a memory 32, an auxiliary storage device 33, a network interface 34, a display device 35, an input device 36, and a graphics processing unit (GPU) 39, which are connected to one another by an internal communication line such as a bus.

The CPU 31, the memory 32, the auxiliary storage device 33, the network interface 34, the display device 35, and the input device 36 are the same as the hardware of the CPU 11, the memory 12, the auxiliary storage device 13, the network interface 14, the display device 15, and the input device 16, respectively. However, the CPU 31 of the confidential information processing server 30 is a TEE-compatible CPU having the TEE function. The memory 32 of the confidential information processing server 30 is a hardware confidence region ensured on the memory by the TEE-compatible CPU 31, and has a TEE confidence region 38 that is an execution region isolated from other regions on the memory. The TEE confidence region 38 is also referred to as an isolation region isolated from the normal region. The GPU 39 includes a processor and executes a program stored in the memory 32 at high speed using a region (normal region) outside the TEE confidence region 38 of the memory 32. The confidential information processing server 30 may not include the GPU 39.

In the present embodiment, the parameter holder terminal 50, the data holder terminal 10, and the confidential information processing server 30 have the TEE function, but a method different from the TEE function, in which arithmetic can be performed in a safe execution region isolated from the normal region on the memory, may be adopted.

A part or all of pieces of processing executed by the CPU 11, the CPU 21, the CPU 31, the CPU 51, and the GPU 39 may be implemented by hardware such as an application specific integrated circuit (ASIC) or a field-programmable gate array (FPGA).

Each of the parameter holder terminal 50, the data holder terminal 10, the processing result user terminal 20, and the confidential information processing server 30 is a computer system configured physically on one computer or on a plurality of computers configured logically or physically. However, the parameter holder terminal 50, the data holder terminal 10, the processing result user terminal 20, and the confidential information processing server 30 may operate in separate threads on the same computer, or may operate on a virtual computer configured on a plurality of physical computer resources.

The network 40 is a communication network such as the Internet, an intranet such as an in-house network, or a satellite line, using wired communication or wireless communication.

### (2) Functional Configuration Example of Confidential Information Processing System 1 and Data Processing Example Of Confidential Inference Processing

FIG. 3 is a diagram illustrating a functional configuration example for confidential inference processing and an example of a data processing flow.

First, the entire confidential inference processing executed by the confidential information processing system 1 according to the present embodiment will be described. In the confidential information processing system 1, first, the parameter holder terminal 50 encrypts machine learning parameter information including confidential information such as each-layer processing concealment setting information and transmits the encrypted machine learning parameter information to the confidential information processing server 30. The each-layer processing concealment setting information is information for designating the machine learning parameters of a neural network such as a convolutional neural network (CNN) and a region in which processing of each layer is executed while being concealed.

Next, the confidential information processing server 30 decrypts the machine learning parameter information in the TEE confidence region 38 and holds parameter concealment setting information in the TEE confidence region 38. Then, parameter concealment processing and input concealment influence removal parameter generation processing are executed in the TEE confidence region 38, concealment machine learning parameter information is output to and held in the normal region, and input concealment removal parameter is held in the TEE confidence region 38.

Next, in the confidential information processing system 1, the data holder terminal 10 encrypts input data including confidential information such as personal information and transmits the encrypted input data to the confidential information processing server 30.

Next, the confidential information processing server 30 decrypts the input data in the TEE confidence region 38, executes processing of each layer of inference processing of Deep Learning including a plurality of processing layers in the TEE confidence region 38 or the normal region according to a result of concealment setting confirmation processing based on the parameter concealment setting information, encrypts an inference result, and transmits the encrypted inference result to the processing result user terminal 20. Then, the processing result user terminal 20 decrypts the received encrypted inference result and acquires the inference result.

Hereinafter, a functional configuration example and an example of a data processing flow of each piece of processing described above will be described in detail with reference to FIG. 3.

The confidential information processing server 30 has, for example, a normal region 310 on the memory 32 for performing high-speed processing by a normal CPU and memory and an acceleration chip such as a GPU. The confidential information processing server 30 further has the TEE confidence region 38 on the memory 32, which is a highly safely isolated processing execution region provided by the TEE function of the CPU.

The normal region 310 includes, for example, an i-th layer processing unit 312. The i-th layer processing unit 312 executes processing of each layer in machine learning of a multilayer structure such as a CNN (hereinafter, a CNN will be described as an example). The CNN is merely an example, and the present embodiment is also applicable to other neural networks such as a recurrent neural network (RNN).

The i-th layer processing unit 312 executes processing of the layer of concealment input data 516 based on concealment machine learning parameter 515 to generate concealment intermediate data 517, and inputs the concealment intermediate data 517 to a parameter concealment influence removal processing unit 533 of the TEE confidence region 38.

The TEE confidence region 38 includes, for example, an i-th layer processing unit 326, a decryption processing unit 522, a decryption processing unit 322, a parameter concealment processing unit 534, an input concealment influence removal parameter generation processing unit 535, and an i-th layer concealment setting confirmation processing unit 536. The TEE confidence region 38 further includes a concealment input data generation processing unit 525, a parameter concealment influence removal processing unit 533, an input concealment influence removal processing unit 538, a random number generation unit 539, and an encryption processing unit 329.

The i-th layer processing unit 326 executes processing of a layer of the CNN. The random number generation unit 539 executes generation of random numbers used for various types of concealment processing. The decryption processing unit 522 decrypts machine learning parameter information 521 (including the machine learning parameters and the each-layer processing concealment setting information) encrypted using an encryption key 532 stored in the TEE confidence region 38. The decryption processing unit 522 stores the decrypted machine learning parameter information 521 in the TEE confidence region 38 as a machine learning parameter 523 and each-layer processing concealment setting information 524. The decryption processing unit 322 decrypts encryption data 103 using an encryption key 331 stored in the TEE confidence region 38, and inputs the decrypted encryption data 103 to the i-th layer concealment setting confirmation processing unit 536.

The parameter concealment processing unit 534 receives the machine learning parameter 523 of each layer included in the machine learning parameter 523 and a parameter protection random number 528 for protecting parameters that is different for each layer and is generated by the random number generation unit 539, and generates the concealment machine learning parameter 515. The parameter concealment processing unit 534 stores the generated concealment machine learning parameters 515 in the normal region 310.

The input concealment influence removal parameter generation processing unit 535 receives the machine learning parameter 523 of each layer and input data protection random number 526 for protecting input data of each layer different for each layer, which is generated by the random number generation unit 539, and generates input concealment influence removal parameter 529. The input concealment influence removal parameter generation processing unit 535 stores the generated input concealment influence removal parameter 529 in the TEE confidence region 38.

The i-th layer concealment setting confirmation processing unit 536 receives the input data (input data 323 or intermediate data 530) of the layer and a layer number i of the processing layer. The i-th layer concealment setting confirmation processing unit 536 refers to information about a region in which i-th layer processing of the layer number is executed in the each-layer processing concealment setting information 524, and inputs the input data to the i-th layer processing unit 326 when a reference result indicates the “confidence region”. In contrast, when the reference result indicates the “normal region”, the i-th layer concealment setting confirmation processing unit 536 inputs the input data to the concealment input data generation processing unit 525.

The i-th layer processing unit 326 executes processing of a layer in machine learning of a multilayer structure such as a CNN in the TEE confidence region 38, outputs an execution result as intermediate data 327 in a case of a layer other than a final layer, and outputs an execution result as an inference result 328 in a case of the final layer.

The concealment input data generation processing unit 525 receives the input data of the layer, reads a random number of the layer in the input data protection random number 526, and reads a temporary input data protection random number 537 generated by the random number generation unit 539 every time the concealment input data generation processing is executed. The concealment input data generation processing unit 525 executes processing of concealing the input data based on these random numbers, and outputs the concealment input data 516. The concealment input data generation processing unit 525 may perform concealment without using the temporary input data protection random number 537.

The parameter concealment influence removal processing unit 533 executes parameter concealment influence removal processing for removing the influence of parameter concealment from the concealment intermediate data 517 on the input concealment intermediate data 517 based on the parameter protection random number 528 of each layer. The parameter concealment influence removal processing unit 533 inputs an execution result of the parameter concealment influence removal processing to the input concealment influence removal processing unit 538.

Based on the input concealment influence removal parameter 529 and the temporary input data protection random number 537 of the layer, the input concealment influence removal processing unit 538 executes, on the input data, input concealment influence removal processing for removing the influence of concealment of the input data to the layer. The input concealment influence removal processing unit 538 outputs the inference result 531 when the layer is other than the final layer, and inputs the inference result 531 to the encryption processing unit 329 when the layer is the final layer. When the concealment is performed without using the temporary input data protection random number 537 in concealment input data generation processing of the layer, the temporary input data protection random number 537 is not used in the input concealment influence removal processing. The temporary input data protection random number 537 may be generated in advance in a state of confidential inference preparation processing.

The encryption processing unit 229 encrypts the input inference result 328 or inference result 531 using an encryption key 332 stored in the TEE confidence region 38, and outputs an encryption inference result 330 via the normal region 310.

The parameter holder terminal 50 includes an encryption processing unit 502 that encrypts the machine learning parameter information 501 and the like using an encryption key 504 stored in the memory 52, the auxiliary storage device 53, and a TEE confidence region 57. The data holder terminal 10 includes an encryption processing unit 102 that encrypts data using an encryption key 104 stored in the memory 12, the auxiliary storage device 13, or the TEE confidence region 17. The processing result user terminal 20 includes a decryption processing unit 202 that decrypts an encryption inference result and the like using an encryption key 204 stored in the memory 22 or the auxiliary storage device 23. Any two or all of the parameter holder terminal 50, the data holder terminal 10, and the processing result user terminal may be the same terminal, and in this case, any two or all of the encryption processing unit 502, the encryption processing unit 102, and the decryption processing unit 202 are provided in the same terminal.

The GPU 39 operates according to an i-th layer processing program loaded on the normal region of the memory 32 to execute processing as the i-th layer processing unit 312. The TEE-compatible CPU 51 operates according to an encryption processing program loaded on the TEE confidence region 57 of the memory 52 to execute processing as the encryption processing unit 502. The TEE-compatible CPU 11 operates according to an encryption processing program loaded on the TEE confidence region 17 of the memory 12 to execute processing as the encryption processing unit 102. The CPU 21 operates according to a decryption processing program loaded on the memory 22 to execute processing as the decryption processing unit 202.

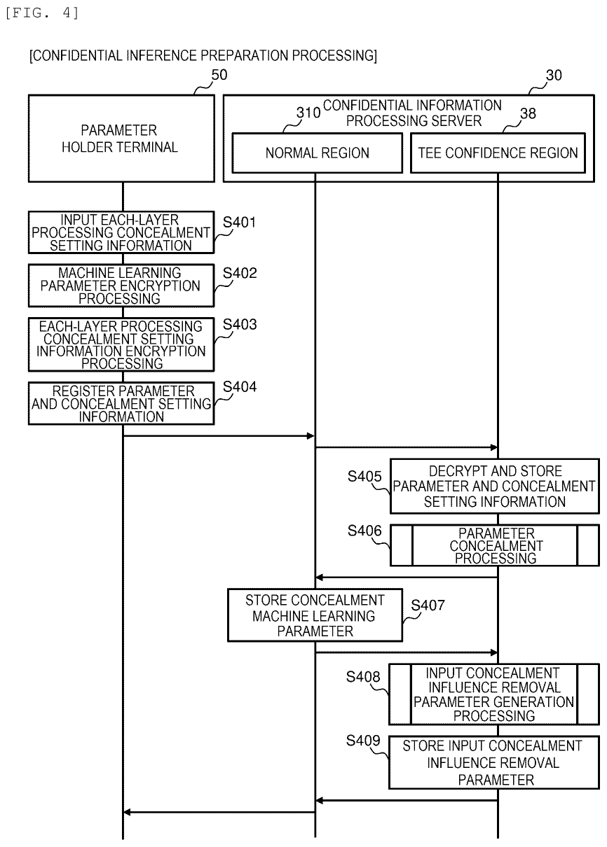

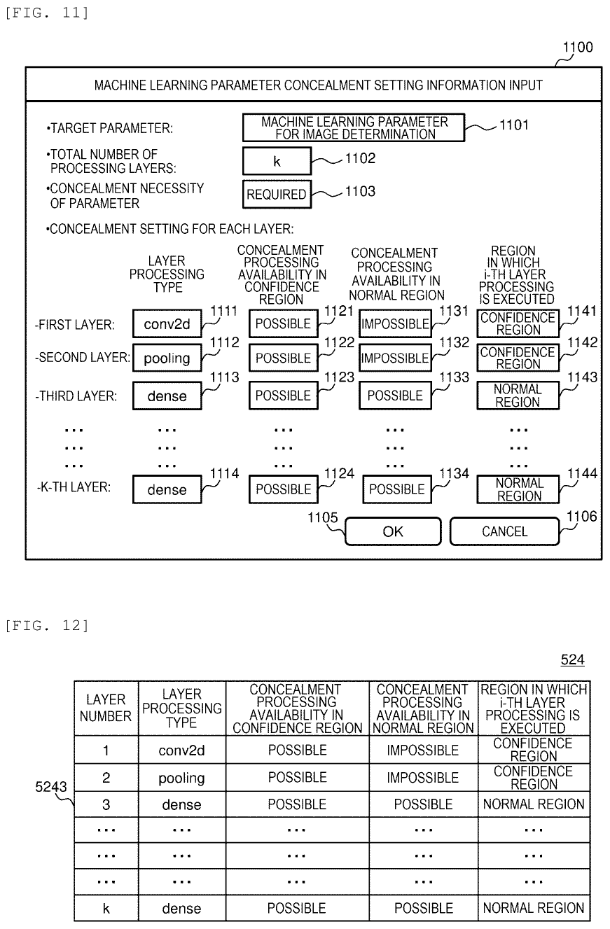

A data processing flow of the confidential inference preparation processing according to the first embodiment will be described below with reference to FIGS. 3 and 4. FIG. 4 is a sequence diagram illustrating an example of the data processing flow of the confidential inference preparation processing. First, the CPU 51 of the parameter holder terminal 50 displays a machine learning parameter concealment setting information input screen illustrated in FIG. 11 on the display device 55 according to a machine learning parameter concealment setting information input screen display program loaded on the memory 52. Then, the CPU 51 receives inputs of a name of a machine learning parameter targeted by the user, the number of layers of the target machine learning parameter, necessity of concealment of the target machine learning parameter, and the each-layer processing concealment setting information of the target machine learning parameter (step S401).

Next, the encryption processing unit 502 of the parameter holder terminal 50 reads the machine learning parameter having a name based on the input of the user illustrated in FIG. 11 from the auxiliary storage device 53 and encrypts the machine learning parameter (step S402). Next, the encryption processing unit 502 reads the each-layer processing concealment setting information based on the input of the user from the memory 52 and encrypts the each-layer processing concealment setting information (step S403). Next, the encryption processing unit 502 registers the machine learning parameters and the each-layer processing concealment setting information by transmitting these pieces of encrypted machine learning parameter information to the confidential information processing server 30 (step S404). Upon receiving encryption data 503, the confidential information processing server 30 inputs the encryption data 503 to the TEE confidence region 38. The decryption processing unit 522 of the TEE confidence region 38 decrypts the encryption data 503 to generate the machine learning parameter 523 and the each-layer processing concealment setting information 524 having a data structure illustrated in FIG. 12 (step S405).

Next, the parameter concealment processing unit 534 executes the parameter concealment processing illustrated in FIG. 6, outputs the execution result to the normal region 310 (step S406), and stores the execution result in the normal region 310 as the concealment machine learning parameter 515 (step S407).

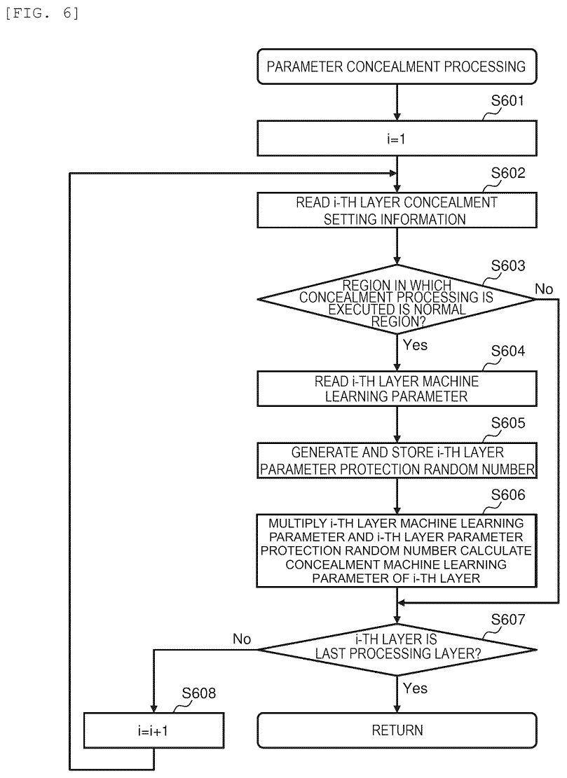

Next, the input concealment influence removal parameter generation processing unit 535 executes the input concealment influence removal parameter generation processing illustrated in FIG. 7 (step S408), stores an execution result as the input concealment influence removal parameter 529 in the TEE confidence region 38, and transmits a response of registration completion to the parameter holder terminal 50 (step S409).

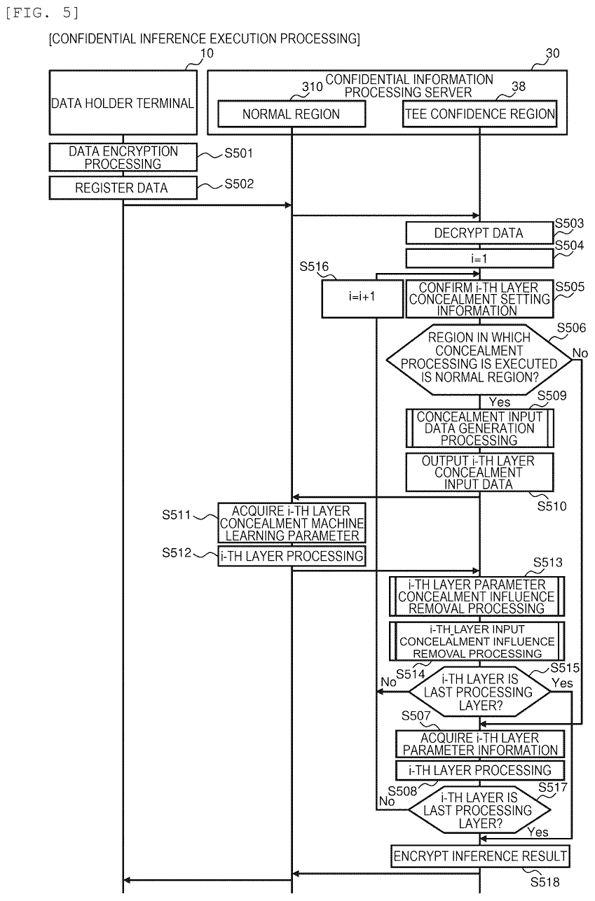

Hereinafter, a data processing flow of a confidential inference execution processing according to the first embodiment will be described with reference to FIGS. 3 and 5. FIG. 5 is a sequence diagram illustrating an example of the data processing flow of the confidential inference execution processing. First, the encryption processing unit 102 of the data holder terminal 10 generates the encryption data 103 by encrypting data 101 including the confidential information (step S501), and performs data registration by transmitting the encryption data 103 to the confidential information processing server 30 (step S502). Upon receiving encryption data 103, the confidential information processing server 30 inputs the encryption data 103 to the TEE confidence region 38. The decryption processing unit 322 of the TEE confidence region 38 decrypts the encryption data 103 to generate the input data 323 (step S503), and initializes a value of a variable i indicating the layer number of the processing to 1 (step S504).

The i-th layer concealment setting confirmation processing unit 536 reads the information on the region in which the i-th layer processing is executed in the each-layer processing concealment setting information 524 (step S505). Thereafter, the i-th layer concealment setting confirmation processing unit 536 transitions to step S506, and inputs the input data to the i-th layer processing unit 326 and reads machine learning parameter information on the i-th layer (step S507) if the read result indicates the “confidence region” (No in step S506). Then, the i-th layer concealment setting confirmation processing unit 536 executes the i-th layer processing in the TEE confidence region 38 (step S508).

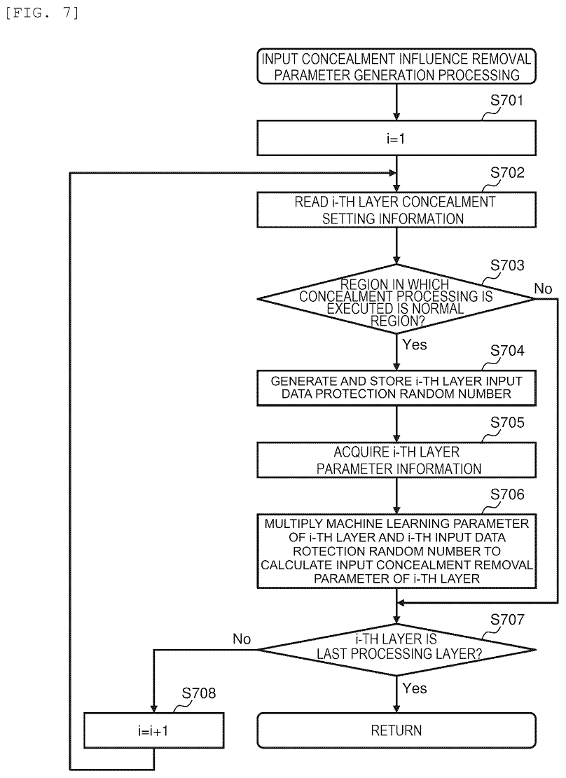

On the other hand, if the read result indicates the “normal region” (Yes in step S506), the i-th layer concealment setting confirmation processing unit 536 inputs the input data to the concealment input data generation processing unit 525 and executes the concealment input data generation processing illustrated in FIG. 8 (step S509). Then, the i-th layer concealment setting confirmation processing unit 536 outputs i-th layer concealment input data of the execution result to the normal region 310 (step S510).

The i-th layer concealment setting confirmation processing unit 536 transitions to step S517 after step S508, and sets output data of the i-th layer processing as input data of the next layer, increments the i, and transitions to step S505 if the i-th layer is not the last processing layer (No in step S517). On the other hand, if the i-th layer is the last processing layer (Yes in step S517), the encryption processing unit 329 encrypts the output data of the i-th layer processing as the inference result, and the i-th layer concealment setting confirmation processing unit 536 transmits the encrypted output data to the processing result user terminal 20 (step S518).

Next, the i-th layer processing unit 312 of the normal region 310 reads the concealment input data 516 of the i-th layer as an input (step S511). Next, the i-th layer processing unit 312 executes the i-th layer processing and inputs the execution result to the parameter concealment influence removal processing unit 533 of the TEE confidence region 38 as the concealment intermediate data 517 (step S512).

For example, the i-th layer processing is executed using Formula (1). Formula (1) represents an arithmetic of calculating an execution result y_i′ by executing a product of an i-th layer concealment input data x_i′ matrix and an i-th layer concealment machine learning parameter W_i′ matrix.

$$\begin{matrix}[ Math . 1 ] & \\ {y}_{i}^{′} = {x}_{i}^{′} {W}_{i}^{′} & ( 1 )\end{matrix}$$

Next, the parameter concealment influence removal processing unit 533 executes the parameter concealment influence removal processing illustrated in FIG. 9 and inputs a parameter concealment influence removal intermediate data of the i-th layer, which is the execution result, to the input concealment influence removal processing unit 538 (step S513).

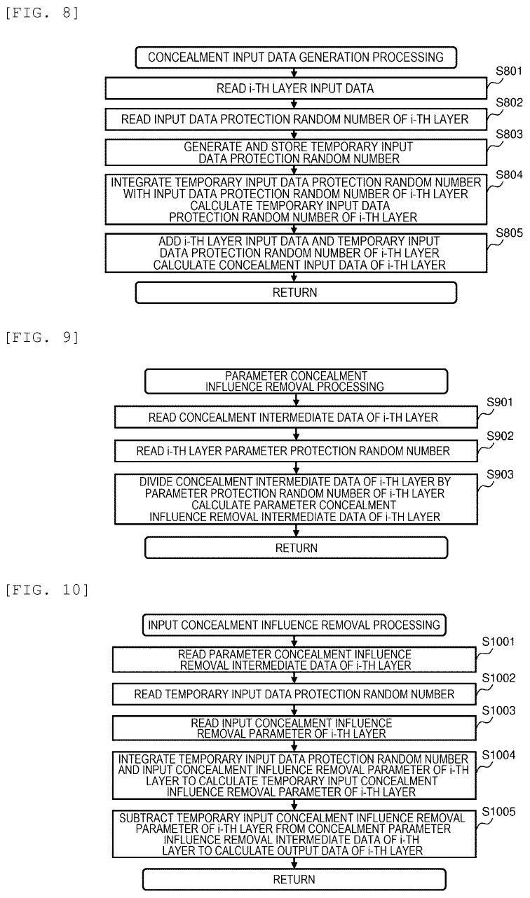

Next, the input concealment influence removal processing unit 538 executes the input concealment influence removal processing illustrated in FIG. 10 (step S514), and transitions to step S515. If the i-th layer is not the last processing layer (No in step S515), the input concealment influence removal processing unit 538 sets the output data of the i-th layer, which is the execution result, as the input data of the next layer, increments the i, and proceeds to step S505. On the other hand, if the i-th layer is the last processing layer (Yes in step S515), the input concealment influence removal processing unit 538 inputs the output data of the i-th layer, which is the execution result, to the encryption processing unit 329 as the inference result. Then, the input concealment influence removal processing unit 538 transmits the encrypted inference result to the processing result user terminal 20 (step S518).

FIG. 6 is a flowchart illustrating an example of the parameter concealment processing. The parameter concealment processing unit 534 of the TEE confidence region 38 first initializes the value of the i to 1 (step S601).

Next, the parameter concealment processing unit 534 reads the information on the region in which the i-th layer processing is executed from the each-layer processing concealment setting information 524 (step S602), and transitions to step S603. If the read result indicates the “confidence region” (No in step 603), the parameter concealment processing unit 534 transitions to step S607. On the other hand, if the read result indicates the “normal region” (Yes in step 603), the parameter concealment processing unit 534 transitions to step S604.

Next, the parameter concealment processing unit 534 reads the machine learning parameter of the i-th layer from the machine learning parameter 523 (step S604). Then, the parameter concealment processing unit 534 acquires the random number for parameter protection of the i-th layer, which is generated by the random number generation unit 539, and adds and stores the random number to the parameter protection random number 528 (step S605).

For example, the machine learning parameter of the i-th layer is expressed using Formula (2). W_i in Formula (2) represents a matrix of p rows and q columns. For example, the i-th layer parameter protection random number for protecting the parameter of the i-th layer is expressed using Formula (3). β_i in Formula (3) is a scalar random number.

$$\begin{matrix}[ Math . 2 ] & \\ {W}_{i} = ( \begin{matrix}{w}_{11} & \cdot & \cdot & {w}_{1 q} \\ \cdot & \cdot & \cdot & \cdot \\ \cdot & \cdot & \cdot & \cdot \\ {w}_{p 1} & \cdot & \cdot & {w}_{pq}\end{matrix} ) & ( 2 )\end{matrix}$$

$$\begin{matrix}[ Math . 3 ] & \\ {β}_{i} \text{:} random & ( 3 )\end{matrix}$$

Next, the parameter concealment processing unit 534 multiplies the machine learning parameter of the i-th layer by the machine learning parameter of the i-th layer to calculate the i-th layer concealment machine learning parameter (step S606).

For example, the concealment machine learning parameter is calculated using Formula (4). W_i′ in Formula (4) is an example of an i-th layer concealment parameter that is a concealed machine learning parameter of the i-th layer, and represents a matrix of p rows and q columns.

$$\begin{matrix}[ Math . 4 ] & \\ {W}_{i}^{′} = {β}_{i} {W}_{i} & ( 4 )\end{matrix}$$

Next, if the i-th layer is not the last processing layer (No in step S607), the parameter concealment processing unit 534 increments the i (step S608) and proceeds to step S602. On the other hand, if the i-th layer is the last processing layer (Yes in step S607), the parameter concealment processing unit 534 outputs a calculated concealment machine learning parameter group to the normal region 310, stores the concealment machine learning parameter group as the concealment machine learning parameter 515, and ends the parameter concealment processing.

FIG. 7 is a flowchart illustrating an example of the input concealment influence removal parameter generation processing. The input concealment influence removal parameter generation processing unit 535 of the TEE confidence region 38 first initializes the value of the i to 1 (step S701).

Next, the input concealment influence removal parameter generation processing unit 535 reads the information on the region in which the i-th layer processing is executed from the each-layer processing concealment setting information 524 (step S702), and transitions to step S703. If the read result indicates the “confidence region” (No in step 703), the input concealment influence removal parameter generation processing unit 535 transitions to step S707. On the other hand, if the read result indicates the “normal region” (Yes in step 703), the input concealment influence removal parameter generation processing unit 535 transitions to step S704.

Next, the input concealment influence removal parameter generation processing unit 535 acquires an input data protection random number for input data protection of the i-th layer, which is generated by the random number generation unit 539, and adds and stores the input data protection random number in the input data protection random number 526 of the TEE confidence region 38 (step S704). Next, the input concealment influence removal parameter generation processing unit 535 reads the machine learning parameter of the i-th layer from the machine learning parameter 523 (step S705).

For example, the input data protection random number of the i-th layer is expressed using Formula (5). In Formula (5), r_i is an example of an i-th layer input data protection random number and represents a matrix of m rows and n columns, and each element of the matrix is a different random number.

$$\begin{matrix}[ Math . 5 ] & \\ {r}_{i} = [ \begin{matrix}{r}_{11} & \cdot & \cdot & {r}_{1 n} \\ \cdot & \cdot & \cdot & \cdot \\ \cdot & \cdot & \cdot & \cdot \\ {r}_{m 1} & \cdot & \cdot & {r}_{mn}\end{matrix} ] & ( 5 )\end{matrix}$$

$${r}_{11} \sim {r}_{mn} \text{:} random$$

In addition, for example, the input data protection random number of the i-th layer is expressed using Formula (6). In Formula (6), r_i\hat{ }(j) is an example of the input data protection random number of the i-th layer and represents a matrix group of m rows and n columns, and each element of the matrix is a different random number.

$$\begin{matrix}[ Math . 6 ] & \\ {r}_{i}^{( j )} = [ \begin{matrix}{r}_{11}^{( j )} & \cdot & \cdot & {r}_{1 n}^{( j )} \\ \cdot & \cdot & \cdot & \cdot \\ \cdot & \cdot & \cdot & \cdot \\ {r}_{m 1}^{( j )} & \cdot & \cdot & {r}_{mn}^{( j )}\end{matrix} ] & ( 6 )\end{matrix}$$

$${r}_{11}^{( j )} \sim {r}_{mn}^{( j )} \text{:} random ( j = 1 , 2 , … , l )$$

Next, the input concealment influence removal parameter generation processing unit 535 multiplies the i-th layer input data protection random number by the i-th layer machine learning parameter to calculate an i-th layer input concealment influence removal parameter (step S706).

For example, the i-th layer input concealment influence removal parameter is calculated using Formula (7). In Formula (7), u_i is an example of an i-th layer input data concealment removal parameter for removing the influence of concealment from the input data of the i-th layer, and is calculated by a product of an i-th layer input data protection random number r_i matrix and the i-th layer machine learning parameter W_i matrix.

[Math. 7]

uᵢ=rᵢWᵢ (7)

In addition, for example, the i-th layer input concealment influence removal parameter is calculated using Formula (8). In Formula (8), u_i\hat{ }(j) is an example of an i-th layer input concealment influence removal parameter group and is calculated by a product of an i-th layer input data protection random number r_i\hat{ }(j) matrix and the i-th layer machine learning parameter W_i matrix.

$$\begin{matrix}[ Math . 8 ] & \\ {u}_{i}^{( j )} = {r}_{i}^{( j )} {W}_{i} & ( 8 )\end{matrix}$$

Next, if the i-th layer is not the last processing layer in step S707 (No in step S707), the input concealment influence removal parameter generation processing unit 535 increments the i (step S708) and transitions to step S702. On the other hand, if the i-th layer is the last processing layer (Yes in step S707), the input concealment influence removal parameter generation processing unit 535 stores the calculated input concealment influence removal parameter group as the input concealment influence removal parameter 529 of the TEE confidence region 38 (step S707). When step S707 ends, the input concealment influence removal parameter generation processing unit 535 ends the input concealment influence removal parameter generation processing.

FIG. 8 is a flowchart illustrating an example of the concealment input data generation processing. The concealment input data generation processing unit 525 of the TEE confidence region 38 first reads the input data of the i-th layer which is the layer (step S801).

For example, the input data of the i-th layer is expressed using Formula (9). In Formula (9), x_i is an example of the input data of the i-th layer and represents a matrix of m rows and n columns, and each element of the matrix is a numerical value.

$$\begin{matrix}[ Math . 9 ] & \\ {x}_{i} = [ \begin{matrix}{x}_{11} & \cdot & \cdot & {x}_{1 n} \\ \cdot & \cdot & \cdot & \cdot \\ \cdot & \cdot & \cdot & \cdot \\ {x}_{m 1} & \cdot & \cdot & {x}_{mn}\end{matrix} ] & ( 9 )\end{matrix}$$

Next, the concealment input data generation processing unit 525 reads the input data protection random number of the i-th layer from the input data protection random number 526 (step S802), acquires a new random number from the random number generation unit 539, and stores the newly acquired random number as the temporary input data protection random number 537 (step S803).

For example, a temporary input data protection random number of the i-th layer is expressed using Formula (10). In Formula (10), α_i is an example of the temporary input data protection random number of the i-th layer and represents a single random number.

[Math. 10]

αᵢ:random (10)

In addition, for example, the temporary input data protection random number of the i-th layer is expressed using Formula (11). In Formula (11), α_i\hat{ }(j) is different random numbers.

$$\begin{matrix}[ Math . 11 ] & \\ {α}_{i}^{( j )} \text{:} random ( j = 1 , 2 , … , l ) & ( 11 )\end{matrix}$$

Next, the concealment input data generation processing unit 525 multiplies the input data protection random number of the i-th layer by the temporary input data protection random number 537 to calculate the temporary input data protection random number of the i-th layer (step S804).

Next, the concealment input data generation processing unit 525 adds the input data of the i-th layer and the temporary input data protection random number of the i-th layer to calculate the concealment input data of the i-th layer, outputs the concealment input data of the i-th layer to the normal region 310, stores the concealment input data as the concealment input data 516, and ends the processing (step S805).

For example, the concealment input data of the i-th layer is calculated using Formula (12). In Formula (12), x_i′ is an example of the concealment input data and represents a matrix of m rows and n columns.

$$\begin{matrix}[ Math . 12 ] & \\ {x}_{i}^{′} = {x}_{i} + {α}_{i} {r}_{i} & ( 12 )\end{matrix}$$

In addition, for example, the concealment input data of the i-th layer is calculated using Formula (13). In Formula (13), x_i′ is an example of the concealment input data and represents a matrix of m rows and n columns.

$$\begin{matrix}[ Math . 13 ] & \\ {x}_{i}^{′} = {x}_{i} + {\sum }_{j = 1}^{l} {α}_{i}^{( j )} {r}_{i}^{( j )} & ( 13 )\end{matrix}$$

FIG. 9 is a flowchart illustrating an example of the parameter concealment influence removal processing. The parameter concealment influence removal processing unit 533 of the TEE confidence region 38 first reads the concealment intermediate data 517 of the i-th layer which is the layer (step S901). Next, the parameter concealment influence removal processing unit 533 reads the parameter protection random number of the i-th layer which is the layer from the parameter protection random number 528 (step S902). Next, the parameter concealment influence removal processing unit 533 divides the concealment intermediate data 517 of the i-th layer by the parameter protection random number of the i-th layer, calculates parameter concealment influence removal intermediate data of the i-th layer, and stores the parameter concealment influence removal intermediate data in the TEE confidence region 38 (step S903).

For example, the parameter concealment influence removal intermediate data of the i-th layer is calculated using Formula (14). In Formula (14), y_i\hat{ }⁻ is an example of the parameter concealment influence removal intermediate data concealment input data of the i-th layer and represents a matrix.

$$\begin{matrix}[ Math . 14 ] & \\ {y}_{i}^{\sim} = \frac{{y}_{i}^{′}}{{β}_{i}} & ( 14 )\end{matrix}$$

FIG. 10 is a flowchart illustrating an example of the input concealment influence removal processing. The input concealment influence removal processing unit 538 of the TEE confidence region 38 first reads the parameter concealment influence removal intermediate data of the i-th layer which is the layer (step S1001). Next, the input concealment influence removal processing unit 538 reads the temporary input data protection random number 537 (step S1002). Next, the input concealment influence removal processing unit 538 reads the input concealment influence removal parameter of the i-th layer, which is the layer, from the input concealment influence removal parameter 529 (step S1003).

Next, the input concealment influence removal processing unit 538 multiplies the temporary input data protection random number 537 by the input concealment influence removal parameter of the i-th layer to calculate the temporary input concealment influence removal parameter of the i-th layer (step S1004).

Next, the input concealment influence removal processing unit 538 outputs a result obtained by subtracting the temporary input concealment influence removal parameter of the i-th layer from concealment parameter influence removal intermediate data of the i-th layer as the output data of the i-th layer, and ends the processing (step S1005).

For example, the output data of the i-th layer is calculated using Formula (15). Formula (15) is an example of i-th layer output data which is an execution result of the input concealment influence removal processing, and y_i is represented by a matrix of Formula (16).

$$\begin{matrix}[ Math . 15 ] & \\ {y}_{i} = {y}_{i}^{\sim} - {α}_{i} {u}_{i} & ( 15 )\end{matrix}$$

$$\begin{matrix}[ Math . 16 ] & \\ {y}_{i} = [ \begin{matrix}{y}_{11} & \cdot & \cdot & {y}_{1 t} \\ \cdot & \cdot & \cdot & \cdot \\ \cdot & \cdot & \cdot & \cdot \\ {y}_{s 1} & \cdot & \cdot & {y}_{st}\end{matrix} ] & ( 16 )\end{matrix}$$

For example, the output data of the i-th layer is calculated using Formula (17). Formula (17) is an example of the output data of the i-th layer, and y_i is represented by the matrix of Formula (16).

$$\begin{matrix}[ Math . 17 ] & \\ {y}_{i} = {y}_{i}^{\sim} - {\sum }_{j = 1}^{l} {α}_{i}^{( j )} {u}_{i}^{( j )} & ( 17 )\end{matrix}$$

FIG. 11 is a dialog diagram illustrating an example of the machine learning parameter concealment setting information input screen. The CPU 51 of the parameter holder terminal 50 displays a machine learning parameter concealment setting information input screen 1100 on the display device 55 according to the machine learning parameter concealment setting information input screen display program loaded on the memory 52.

A target parameter input unit 1101 of the machine learning parameter concealment setting information input screen 1100 is an input form in which the user inputs identification information (file name or the like) of the machine learning parameter to be transmitted to the confidential information processing server 30. A processing layer total number input unit 1102 is an input form in which the user inputs a total number of the target machine learning parameter or the CPU 51 reads and inputs the number of layers from the machine learning parameter. A parameter concealment necessity input unit 1103 is an input form in which the user designates necessity of concealment of the target machine learning parameter to the confidential information processing server 30 or the CPU 51 reads and inputs a concealment requirement from the target machine learning parameter.

Layer processing type input units 1111 to 1114 of the machine learning parameter concealment setting information input screen 1100 are input forms in which the user inputs the type of arithmetic of each processing layer or the CPU 51 reads and inputs the type of arithmetic of each layer from the target machine learning parameter. Confidence region concealment processing availability input units 1121 to 1124 are input forms in which the user inputs whether the arithmetic of the layer can be processed in the TEE confidence region 38 or the CPU 51 performs the input based on the type of arithmetic of each layer from the target machine learning parameter. Normal region concealment processing availability input units 1131 to 1134 are input forms in which the user inputs whether the arithmetic of the layer can be performed in a concealed way in the normal region 310 or the CPU 51 performs the input based on the type of arithmetic of each layer from the target machine learning parameter. i-th layer processing execution region input units 1141 to 1144 are input forms in which the user inputs whether the arithmetic of the layer is executed in the normal region 310 or the TEE confidence region 38 or the CPU 51 performs the input based on the type of the arithmetic of each layer from the target machine learning parameter.

An input confirmation operation unit 1105 of the machine learning parameter concealment setting information input screen 1100 is an input button to be pressed by the user using the input device 56 such as a mouse when confirming an input content to each form. An input cancellation operation unit 1106 is an input button to be pressed by the user using the input device 56 such as a mouse when cancelling the input content to each form and stops the input.

FIG. 12 is a table illustrating an example of a data structure of the each-layer processing concealment setting information. In FIG. 12, as an example of the each-layer processing concealment setting information 524 of the TEE confidence region 38, the each-layer processing concealment setting information 524 storing information on concealment settings of processing of each layer of the machine learning parameter transmitted by the parameter holder terminal 50 is illustrated.

The each-layer processing concealment setting information 524 in FIG. 12 includes columns of a layer number, a layer processing type, concealment processing availability in the confidence region, concealment processing availability in the normal region, and a region in which the i-th layer processing is executed. Specifically, for example, a record 5243 in the third row indicates processing of executing a linear arithmetic in which the processing type of the third layer of the plurality of processing layers is dense. The record 5243 indicates that it is possible to perform concealment processing of processing confidential parameter and data in the confidence region in a protecting way. In addition, the record 5243 indicates that it is possible to perform the concealment processing of processing the confidential parameter and data in the normal region in a protecting way and a region in which third layer processing, which is designated by the user, is executed is the normal region. Of course, the each-layer processing concealment setting information 524 that can be used in the confidential information processing system 1 according to the present embodiment is not limited to the setting information data as described above, and the entire data structure such as a database can be adopted.

### (3) Effects of Embodiment

When receiving deposit of the machine learning parameter, which is the confidential information, the confidential information processing server 30 of the embodiment described above executes the parameter concealment processing on the machine learning parameter in the TEE confidence region before arranging the machine learning parameter in the normal region such as a GPU in which high-speed processing is possible. Therefore, it is possible to prevent information leakage of the machine learning parameter, which is the confidential information, to a server administrator who can access data in the normal region of the confidential information processing server 30 or a cyber attacker who has taken the authority of the administrator.

When executing the inference processing including processing of a plurality of layers such as CNN on the input information, which is the confidential information, in the normal region, the confidential information processing server 30 executes the concealment input data generation processing in the TEE confidence region and then outputs the concealment input data to the normal region. Then, processing of each layer such as a CNN is executed in the normal region such as a GPU in which high-speed processing is possible based on the concealment input data and the concealment machine learning parameter, and the concealment intermediate data is generated. Then, the generated concealment intermediate data is input to the TEE confidence region, and then the parameter concealment influence removal processing and the input concealment influence removal processing are executed to calculate an inference processing result. Then, the inference processing result, which is the confidential information, is encrypted in the TEE confidence region and transmitted to the processing result user terminal 20 or the data holder terminal 10. Therefore, the input data, the machine learning parameter, and the inference result, which are the confidential information, can be always handled in a concealed or encrypted state when being stored or processed in the normal region such as a GPU in which high-speed processing is possible. Accordingly, when the inference processing including processing of the plurality of layers is executed in the normal region in which high-speed processing such as a GPU is possible, information leakage of the input data, the machine learning parameter, and the inference processing result, which the confidential information, to an attacker of the confidential information processing server 30 can be prevented.

In addition, when executing the inference processing including processing of the plurality of layers such as CNN on the input information, which is the confidential information, in the normal region, the confidential information processing server 30 generates a temporary random number for use only with the input information in the TEE confidence region. Then, after executing the concealment input data generation processing including random numbers different for each piece of input information, the concealment input data is output to the normal region. Therefore, when a different temporary random number is not used for each piece of the input information, the server administrator of the confidential information processing server 30 or the cyber attacker intentionally sets the input information to 0 and performs the concealment input data generation processing. Therefore, it is possible to prevent information leakage caused by specifying the input data protection random number and exposing the input information.

The confidential information processing server 30 can designate whether to perform processing in the normal region or in the TEE confidence region for each layer of the machine learning parameter based on the each-layer processing concealment setting information designated by the user of the parameter holder terminal 50. Therefore, it is possible to designate a region in which processing for each layer is executed in consideration of whether processing by a different GPU is possible, whether there is an acceleration effect, and the like for each feature such as the type of each layer of the machine learning parameter, and it is possible to improve the efficiency of the inference processing including processing of the plurality of layers such as a CNN.

### (4) Other Embodiments

(4-1) Execution Subject of Processing of i-Th Layer

In the embodiment described above, the confidential information processing server 30 executes the processing of the i-th layer in the normal region 310, and conceals and cancels the concealment of the i-th layer parameter and the i-th layer input data in the TEE confidence region 38. The processing of the i-th layer is not necessarily executed by the confidential information processing server 30, and may be executed by an external device that has a normal region and is connected to the confidential information processing server 30 via communication. That is, the confidential information processing server 30 outputs an execution instruction of the processing of the i-th layer to the external device. Then, the external device executes the processing of the i-th layer in the normal region in response to the execution instruction, and returns an execution result to the confidential information processing server 30. Then, the confidential information processing server 30 may acquire the execution result of the processing of the i-th layer from the external device.

(4-2) Temporary Random Number for Input Data Protection of i-Th Layer

In the embodiment described above, the concealment of the input data of the i-th layer is performed using the i-th layer temporary input data protection random number α_i·r_i (Formula (12)) obtained by multiplying the i-th layer input data protection random number (Formula (5)) by the temporary random number α_i (Formula (10)) for protecting the input data of the i-th layer. However, the temporary random number α_i of the i-th layer is not necessarily used, and “1” may be used instead of the temporary random number α_i of the i-th layer.

(4-3) i-th Layer Input Data Protection Random Number

In the embodiment described above, the concealment of the input data of the i-th layer is performed using the i-th layer temporary input data protection random number α_i·r_i (Formula (12)) obtained by multiplying the i-th layer input data protection random number (Formula (5)) by the temporary random number α_i (Formula (10)) for protecting the input data of the i-th layer. However, the i-th layer input data protection random number is not necessarily used, and instead of the i-th layer input data protection random number, a matrix that is a matrix having the same size as the i-th layer input data protection random number and having all elements being “1” may be used.

The invention is not limited to the embodiment described above and includes various modifications and equivalent configurations within the scope of the appended claims. For example, the embodiment described above has been described in detail to facilitate understanding of the invention, and the invention is not limited to those including all the configurations described above. Another configuration may be added to, deleted from, or replaced with a part of the configuration of a certain embodiment.

A part or all of the configurations, functions, processing units, processing methods, and the like described above may be implemented by hardware by, for example, designing with an integrated circuit. The configurations, functions, processing units, processing method, and the like described above may be implemented by software by a processor interpreting and executing a program for implementing each function.

Information such as a program, a table, and a file for implementing each function can be stored in a storage device such as a memory, a hard disk, and a solid state drive (SSD), or in a recording medium such as an IC card, an SD card, and a DVD.

Control lines and information lines considered to be necessary for descriptions are illustrated in the drawings, and not all control lines and information lines necessary for implementation are shown. Actually, almost all configurations may be considered to be connected to one another.

In addition to personal information, the invention can also achieve the same effect when the confidential information that is highly confidential and limited from disclosure to the outside under in-house rules or the like, such as trade secrets, is provided to an external organization or the like while being concealed.

The invention can improve the processing efficiency of advanced deep learning or the like in a plurality of organizations that handle the personal information such as customer information and medical information and the confidential information such as trade secrets while keeping the personal information and the trade secret information concealed, and thus can be widely applied to information processing systems for public and private services that cooperate with various types of confidential information.

### REFERENCE SIGNS LIST

1: confidential information processing system
30: confidential information processing server
31: CPU
38: TEE confidence region
310: normal region
312: i-th layer processing unit

1. An information processing method performed by an information processing system configured to execute information processing by a neural network including a plurality of i-th layers (i is a natural number of 1 or more and N or less), wherein
the information processing system includes a processor and a memory,
the memory has an isolation region that is a trusted execution environment (TEE) isolated from a normal region,
the isolation region holds
an i-th layer parameter used for processing of the i-th layer,
an i-th layer parameter protection random number that is a random number for protecting the i-th layer parameter,
an i-th layer input data to be input to the i-th layer, and
an i-th layer input data protection random number that is a random number for protecting the i-th layer input data, and
in the isolation region, the processor executes processing including
executing, for each of the i-th layers, parameter concealment processing of generating an i-th layer concealment parameter in which the i-th layer parameter is concealed by multiplying the i-th layer parameter by the i-th layer parameter protection random number, and outputting the i-th layer concealment parameter to the normal region,
executing, for each of the i-th layers, input concealment influence removal parameter generation processing of generating an i-th layer input data concealment removal parameter for removing concealment applied to the i-th layer input data by multiplying the i-th layer parameter by the i-th layer input data protection random number and of holding the generated i-th layer input data concealment removal parameter in the isolation region,
executing concealment input data generation processing of generating i-th layer concealment input data in which the i-th layer input data is concealed by adding the i-th layer input data protection random number to the i-th layer input data, and outputting the i-th layer concealment input data to the normal region as the i-th layer input data,
executing parameter concealment influence removal processing of acquiring, from the normal region, an execution result of the processing of the i-th layer executed on the i-th layer concealment input data based on the i-th layer concealment parameter in the normal region and of dividing the execution result by the i-th layer parameter protection random number, and
executing input concealment influence removal processing of subtracting the i-th layer input data concealment removal parameter from an execution result of the parameter concealment influence removal processing, and setting an execution result of the input concealment influence removal processing as i-th layer output data output from the i-th layer.

2. The information processing method according to claim 1, wherein
the memory has the normal region, and
in the normal region, the processor executes processing including executing the processing of the i-th layer on the i-th layer concealment input data based on the i-th layer concealment parameter, and outputting the execution result of the processing of the i-th layer to the isolation region.

3. The information processing method according to claim 1, wherein
in the isolation region, the processor executes processing including
executing the concealment input data generation processing of generating a temporary random number for each piece of processing of the i-th layer for each piece of the i-th layer input data and of generating the i-th layer concealment input data by adding a result obtained by multiplying the i-th layer input data protection random number by the temporary random number to the i-th layer input data, and outputting the i-th layer concealment input data to the normal region as the i-th layer input data, and
executing the input concealment influence removal processing of subtracting a result obtained by multiplying the i-th layer input data concealment removal parameter by the temporary random number from the execution result of the parameter concealment influence removal processing, and setting the execution result of the input concealment influence removal processing as the i-th layer output data output from the i-th layer.

4. The information processing method according to claim 3, wherein
the processor uses, instead of the i-th layer input data protection random number, a matrix having the same size as the i-th layer input data protection random number and having all elements being 1.

5. The information processing method according to claim 1, wherein
the isolation region holds each-layer processing concealment setting information that is information indicating whether the processing of the i-th layer is to be executed in the normal region or the isolation region, and
the processor executes the processing of the i-th layer in either the normal region or the isolation region according to the each-layer processing concealment setting information.

6. The information processing method according to claim 1, wherein
the neural network is a convolutional neural network (CNN), and
the i-th layer parameter is a machine learning parameter of the CNN.

7. An information processing system for executing information processing by a neural network including a plurality of i-th layers (i is a natural number of 1 or more and N or less), the information processing system comprising:
a processor; and
a memory, wherein
the memory has an isolation region that is a trusted execution environment (TEE) isolated from a normal region,
the isolation region holds
an i-th layer parameter used for processing of the i-th layer,
an i-th layer parameter protection random number that is a random number for protecting the i-th layer parameter,
an i-th layer input data to be input to the i-th layer, and
an i-th layer input data protection random number that is a random number for protecting the i-th layer input data, and
in the isolation region, the processor
executes, for each of the i-th layers, parameter concealment processing of generating an i-th layer concealment parameter in which the i-th layer parameter is concealed by multiplying the i-th layer parameter by the i-th layer parameter protection random number, and outputs the i-th layer concealment parameter to the normal region,
executes, for each of the i-th layers, input concealment influence removal parameter generation processing of generating an i-th layer input data concealment removal parameter for removing concealment applied to the i-th layer input data by multiplying the i-th layer parameter by the i-th layer input data protection random number and of holding the generated i-th layer input data concealment removal parameter in the isolation region,
executes concealment input data generation processing of generating i-th layer concealment input data in which the i-th layer input data is concealed by adding the i-th layer input data protection random number to the i-th layer input data, and outputs the i-th layer concealment input data to the normal region as the i-th layer input data,
executes parameter concealment influence removal processing of acquiring, from the normal region, an execution result of the processing of the i-th layer executed on the i-th layer concealment input data based on the i-th layer concealment parameter in the normal region and of dividing the execution result by the i-th layer parameter protection random number, and
executes input concealment influence removal processing of subtracting the i-th layer input data concealment removal parameter from an execution result of the parameter concealment influence removal processing, and sets an execution result of the input concealment influence removal processing as i-th layer output data output from the i-th layer.

8. The information processing system according to claim 7, wherein
the memory has the normal region, and
in the normal region, the processor executes the processing of the i-th layer on the i-th layer concealment input data based on the i-th layer concealment parameter, and outputs the execution result of the processing of the i-th layer to the isolation region.

9. The information processing system according to claim 7, wherein
in the isolation region, the processor
executes the concealment input data generation processing of generating a temporary random number for each piece of processing of the i-th layer for each piece of the i-th layer input data and of generating the i-th layer concealment input data by adding a result obtained by multiplying the i-th layer input data protection random number by the temporary random number to the i-th layer input data, and outputs the i-th layer concealment input data to the normal region as the i-th layer input data, and
executes the input concealment influence removal processing of subtracting a result obtained by multiplying the i-th layer input data concealment removal parameter by the temporary random number from the execution result of the parameter concealment influence removal processing, and sets the execution result of the input concealment influence removal processing as the i-th layer output data output from the i-th layer.

10. The information processing system according to claim 9, wherein
the processor uses, instead of the i-th layer input data protection random number, a matrix having the same size as the i-th layer input data protection random number and having all elements being 1.

11. The information processing system according to claim 7, wherein
the isolation region holds each-layer processing concealment setting information that is information indicating whether the processing of the i-th layer is to be executed in the normal region or the isolation region, and
the processor executes the processing of the i-th layer in either the normal region or the isolation region according to the each-layer processing concealment setting information.

12. The information processing system according to claim 7, wherein
the neural network is a convolutional neural network (CNN), and
the i-th layer parameter is a machine learning parameter of the CNN.
